(19) United States
(12) Patent Application Publication
(10) Pub. No.: US 2021/0355996 A1
(43) Pub. Date: Nov. 18, 2021

(54) WHEEL BEARING DEVICE

(71) Applicant: NSK Deutschland GmbH, Ratingen (DE)

(72) Inventor: Daniel Czech, Cologne (DE)

(21) Appl. No.: 17/315,739

(22) Filed: May 10, 2021

(30) Foreign Application Priority Data
May 13, 2020 (DE) 10 2020 002 878.0

(51) Int. Cl. F16C 33/80

(52) U.S. Cl. CPC F16C 33/805; F16C 2326/02

(57) ABSTRACT

The present invention relates to a wheel-bearing device (10), comprising: an outer-ring element (30), a wheel-hub element (20), and a sealing device (40), which seals a gap between the outer-ring element (30) and the wheel-hub element (20), wherein the wheel-hub element (20) comprises an inner axial wheel-hub end face (22) and a cylindrical wheel-hub portion (24), the outer-ring element (30) comprises a radial outer-ring inner face (32), the sealing device (40) comprises a wheel-hub sealing element (50) and an outer-ring sealing element (70), the wheel-hub sealing element (50) comprises a substantially rigid slinger-ring element (51) and an elastomeric wheel-hub sealing structure (60) arranged thereon, the outer-ring sealing element (70) comprises a substantially rigid insertion element (71) and an elastomeric outer-ring sealing structure (80) arranged thereon, the slinger-ring element (51) comprises a cylindrical wheel-hub fastening portion (54) and a radial wheel-hub sealing portion (56), the insertion element (71) comprises a cylindrical outer-ring fastening portion (72) and a radial outer-ring sealing portion (74), the elastomeric outer-ring sealing structure (80) comprises an axial outer-ring sealing lip (81), which extends between the radial outer-ring sealing portion (74) and the radial wheel-hub sealing portion (56) substantially in an axial direction and contacts the radial wheel-hub sealing portion (56), the radial wheel-hub sealing portion (56) is arranged so as to be axially spaced from the inner axial wheel-hub end face (22), and the elastomeric wheel-hub sealing structure (60) comprises an axial wheel-hub sealing lip (62), which extends between the radial wheel-hub sealing portion (56) and the inner axial wheel-hub end face (22) substantially in an axial direction and contacts the inner axial wheel-hub end face (22).

The present invention relates to a wheel-bearing device.

Conventional wheel-bearing devices substantially consist of an outer-ring element for attachment to a vehicle body, a wheel-hub element for connection to a wheel, a bearing for rotatably mounting the wheel-hub element in the outer-ring element, and a sealing device, which is arranged in a gap between the outer-ring element and the wheel-hub element in order to prevent dirt from entering the bearing and to prevent grease from leaking out out of the bearing. The sealing device can be designed in various ways here.

Conventional sealing devices often consist of a sealing element, which comprises a plurality of sealing lips, the sealing element being mounted on the outer-ring element by a metal insert. In order to reduce frictional losses in wheel-bearing devices, conventional sealing devices use slingers, which are used together with the sealing lips to provide dynamic sealing with low frictional properties. In this case, conventional slingers are usually fastened to the wheel-hub element, with there being a risk that water and dirt could penetrate into an axial gap between an end face of the wheel hub and the slinger. Water and dirt that penetrate into an axial gap between an end face of the wheel hub and the slinger can cause corrosion on the wheel-hub element, which is accompanied by expansion of the wheel-hub element. Furthermore, penetrating water and dirt can freeze when it is cold, which likewise means that an expanding effect can occur between the wheel-hub element and the slinger fastened thereto. The above-described expansion of the wheel-hub element and the expanding effect if freezing occurs cause the slinger to be displaced in the axial direction towards the center of the vehicle over the service life of the wheel-bearing device. Alternatively or additionally, the slinger can be displaced in the axial direction towards the center of the vehicle over the service life of the wheel-bearing device due to thermal expansion of the wheel hub or the slinger itself. Furthermore, deformation of the wheel-hub flange under load, i.e. during driving, if the slinger abuts the wheel-hub flange or is arranged in the vicinity thereof, can likewise cause the slinger to be axially displaced towards the center of the vehicle over the service life of the wheel-bearing device. By displacing the slinger, which comprises the contact surface or sealing surface for the sealing lips, towards the center of the vehicle, the contact surface or sealing surface between the slinger and the sealing lips changes over the service life of the sealing device. In wheel-bearing devices, the change in or displacement of the contact surface or sealing surface is generally accompanied by deterioration of the sealing function and an increase in frictional losses during driving.

Furthermore, in conventional sealing devices for wheel-bearing devices, there is the problem that heating under load, i.e. during driving, causes thermal expansion of the air in the bearing. The overpressure that develops here in conventional wheel-bearing devices is relieved again over/by the sealing device during driving, meaning that, once the wheel-bearing device cools down after driving, a negative pressure develops in the region of the bearing which results in dirt and water being drawn in.

The object of the present invention is therefore to provide a wheel-bearing device, in particular a sealing device for a wheel-bearing device, which both allows for secure sealing and reduces frictional losses over a long service life of the wheel-bearing device. Since frictional losses in wheel-bearing devices are caused by the rotation of the wheel, or in other words are directly linked to the vehicle being driven, reducing frictional losses by means of the wheel-bearing device of the present invention makes it possible to increase the overall efficiency of vehicles.

The above-described object is achieved by the subject-matters of the independent claims, with preferred embodiments being the subject-matter of the dependent claims.

One aspect of the invention relates to a wheel-bearing device, comprising:
an outer-ring element for connection to a vehicle body,
a wheel-hub element for connection to a wheel, and
a sealing device, which seals a gap between the outer-ring element and the wheel-hub element, wherein
   the wheel-hub element comprises an inner axial wheel-hub end face, which faces the outer-ring element, and a cylindrical wheel-hub portion, which is arranged in the radial interior of the outer-ring element at least in part,
   the outer-ring element comprises a radial outer-ring inner face, which faces the cylindrical wheel-hub portion,
   the sealing device comprises a wheel-hub sealing element, which is mounted on the wheel-hub element, and an outer-ring sealing element, which is mounted on the outer-ring element, the wheel-hub sealing element comprises a substantially rigid slinger-ring element and an elastomeric wheel-hub sealing structure arranged thereon,
   the outer-ring sealing element comprises a substantially rigid insertion element and an elastomeric outer-ring sealing structure arranged thereon,
   the slinger-ring element comprises a cylindrical wheel-hub fastening portion, which is connected to the cylindrical wheel-hub portion, and a radial wheel-hub sealing portion, which extends outwards from the wheel-hub element substantially in a radial plane,
   the insertion element comprises a cylindrical outer-ring fastening portion, which is connected to the radial outer-ring inner face, and a radial outer-ring sealing portion, which extends inwards from the outer-ring element substantially in a radial plane,
   the elastomeric outer-ring sealing structure comprises an axial outer-ring sealing lip, which extends between the radial outer-ring sealing portion and the radial wheel-hub sealing portion substantially in an axial direction and contacts the radial wheel-hub sealing portion,
   the radial wheel-hub sealing portion is arranged so as to be axially spaced from the inner axial wheel-hub end face, and
   the elastomeric wheel-hub sealing structure comprises an axial wheel-hub sealing lip, which extends between the radial wheel-hub sealing portion and the inner axial wheel-hub end face substantially in an axial direction and contacts the inner axial wheel-hub end face.

For example, the outer-ring element, which is configured to be connected a vehicle body, may be an outer-ring element that is substantially annular at least in portions.

The inner axial wheel-hub end face of the wheel-hub element, which faces the outer-ring element, is, in other words, a wheel-hub end face of the wheel-hub element which is arranged on the wheel-hub element axially inwards or towards the center of the vehicle in the width direction of the vehicle.

The axial outer-ring sealing lip, which extends between the radial outer-ring sealing portion and the radial wheel-hub sealing portion substantially in an axial direction and contacts the radial wheel-hub sealing portion, can in particular dynamically contact the radial wheel-hub sealing portion. In other words, by way of example, the axial outer-ring sealing lip can be configured not to rotate, even when a vehicle is being driven, while the radial wheel-hub sealing portion contacted by the axial outer-ring sealing lip can be configured to rotate together with the wheel or the wheel hub when a vehicle is being driven, such that the axial outer-ring sealing lip rubs against the radial wheel-hub sealing portion when a vehicle is being driven, which may result in frictional losses. Owing to the direct connection between possible friction of the axial outer-ring sealing lip on the radial wheel-hub sealing portion and a vehicle being driven, the wheel-bearing device and/or sealing device has a direct impact on the overall efficiency of a vehicle.

The axial wheel-hub sealing lip, which extends between the radial wheel-hub sealing portion and the inner axial wheel-hub end face substantially in an axial direction and contacts the inner axial wheel-hub end face, can in particular statically contact the inner axial wheel-hub end face. In other words, by way of example, the axial wheel-hub sealing lip can be configured to rotate together with the wheel or the wheel hub when a vehicle is being driven, while the inner axial wheel-hub end face contacted by the axial wheel-hub sealing lip can likewise be configured to rotate together with the wheel or the wheel hub when a vehicle is being driven. If both the axial wheel-hub sealing lip and the inner axial wheel-hub end face are configured to rotate together with the wheel or the wheel hub, they can both rotate at an identical speed, meaning that static contact can be configured between the axial wheel-hub sealing lip and the inner axial wheel-hub end face, and therefore friction or frictional movement does not occur between the axial wheel-hub sealing lip and the inner axial wheel-hub end face.

Advantageously, the above-described wheel-bearing device makes it possible for the axial wheel-hub sealing lip to prevent dirt, water and other particles from penetrating into an axial gap between the slinger-ring element and the wheel hub.

Furthermore, because the elastomeric wheel-hub sealing structure comprises an axial wheel-hub sealing lip, which is mounted on the wheel hub by the slinger-ring element, said elastomeric wheel-hub sealing structure can be configured to rotate together with the wheel of the vehicle when it rotates. Advantageously, by means of rotation of the axial wheel-hub sealing lip, dirt, water and other particles which penetrate between the outer-ring element and the wheel-hub element can be expelled again by centrifugal action. The wheel-bearing device according to the invention advantageously makes it possible for undesired particles, water or dirt to be removed from the wheel-bearing device again, in particular to be removed by themselves or passively when the vehicle is driven. Passive removal of undesired particles, water or dirt from the wheel-bearing device during driving can advantageously prevent dirt, water and other particles from penetrating into the axial gap between the slinger-ring element and the axial wheel-hub end face. By preventing dirt, water and other particles from penetrating into the axial gap between the slinger-ring element and the axial wheel-hub end face, corrosion on the wheel-hub element and expansion of freezing water on the wheel-hub element can be prevented. Therefore, the slinger-ring element can in turn advantageously be prevented from being displaced axially inwards or towards the center of the vehicle. Furthermore, the axial distance provided between the radial wheel-hub sealing portion of the slinger-ring element and the inner axial wheel-hub end face can prevent the slinger from being displaced in the axial direction towards the center of the vehicle over the service life of the wheel-bearing device due to thermal expansion of the wheel-hub element or the slinger-ring element. Furthermore, the axial distance provided between the radial wheel-hub sealing portion of the slinger-ring element and the inner axial wheel-hub end face causes the slinger to be displaced axially towards the center of the vehicle over the service life of the wheel-bearing device due to deformation of the wheel-hub flange or the inner axial wheel-hub end face under load. Instead, the axial wheel-hub sealing lip of the elastomeric wheel-hub sealing structure causes deformation of the wheel-hub flange or the axial wheel-hub end face towards the slinger to be mitigated under load, i.e. during driving. The above-described effects can in turn prevent a change in or displacement of the contact or sealing or frictional surfaces, as provided by the slinger-ring element for the axial outer-ring sealing lip. By maintaining the frictional surfaces, as provided by the slinger-ring element, over the service life of the wheel-bearing device, frictional losses can advantageously be prevented from increasing over the service life of the wheel-bearing device and a sealing function of the wheel-bearing device can be prevented from deteriorating over its service life.

The axial wheel-hub sealing lip can also advantageously prevent water or dirt from being able to penetrate into the gap between the slinger-ring element and the wheel-hub element, in particular in the region of the wheel-hub fastening portion. In particular, water or dirt can also be prevented from being able to advance as far as a rolling-element support region or rolling-element arrangement region of the wheel-bearing device. As a result, the service life of the wheel-bearing device can be further increased. The rolling-element support region of the wheel-bearing device may be arranged axially inwards from the sealing device, i.e. may be arranged so as to be offset further towards the center of the vehicle in the width direction of the vehicle. Rolling elements such as balls, tapered rollers or cylindrical rollers may be arranged in the rolling-element support region of the wheel-bearing device in order transmit radial and/or axial forces between the wheel-hub element and the outer-ring element while rotation of the wheel-hub element relative to the outer-ring element is made possible. A rolling-element support region of the outer-ring element may comprise a running surface for the rolling elements and may be formed in one piece with the outer-ring element or may be arranged on the outer-ring element as a separate component, for example in the form of an outer ring of a rolling bearing. A rolling-element support region of the wheel-hub element may comprise a running surface for the rolling elements and may be formed in one piece with the wheel-hub element or may be arranged on the wheel-hub element as a separate component, for example in the form of an inner ring of a rolling bearing.

Furthermore, the arrangement in which the substantially rigid insertion element comprises a radial outer-ring sealing portion and the slinger-ring element likewise comprises a radial wheel-hub sealing portion makes it possible to configure a sealing device comprising a sealing labyrinth which both provides reliable sealing and only generates or causes low frictional losses.

In exemplary embodiments of the wheel-bearing devices, the radial wheel-hub sealing portion of the slinger-ring element may be arranged axially outside the radial outer-ring sealing portion of the insertion element. In other words, the radial wheel-hub sealing portion of the slinger-ring element may be arranged further towards the outside than the radial outer-ring sealing portion of the insertion element in the width direction of the vehicle. In the above-described exemplary embodiment, the axial outer-ring sealing lip extends outwards substantially in the axial direction or outwards in the width direction of the vehicle.

In alternative embodiments, the radial wheel-hub sealing portion may be arranged axially inside the radial outer-ring sealing portion, meaning that the axial outer-ring sealing lip may also accordingly extend inwards substantially in the axial direction or inwards in the width direction of the vehicle.

In exemplary embodiments, the elastomeric wheel-hub sealing structure may be arranged on the substantially rigid slinger-ring element by vulcanization or by means of a vulcanization step on the slinger-ring element. In other alternative embodiments, the elastomeric wheel-hub sealing structure may be arranged on the slinger-ring element by adhesion or by mounting in another way. The elastomeric wheel-hub sealing structure may cover the entire surface of the slinger-ring element or may cover the surface of said slinger-ring element in portions. In preferred embodiments, the cylindrical wheel-hub fastening portion is in particular free of the elastomeric wheel-hub sealing structure on its radial inner face in order to allow a rigid connection or attachment to the wheel-hub element.

In exemplary embodiments, the elastomeric outer-ring sealing structure may be arranged on the substantially rigid insertion element by vulcanization or by means of a vulcanization step on the insertion element. In other alternative embodiments, the elastomeric outer-ring sealing structure may be arranged on the insertion element by adhesion or by mounting in another way. The elastomeric outer-ring sealing structure may cover the entire surface of the insertion element or may cover the surface of said insertion element in portions. In preferred embodiments, the cylindrical outer-ring fastening portion is in particular free of the elastomeric outer-ring sealing structure on its radial outer face in order to allow a rigid connection or attachment to the outer-ring element.

In the following, various terms are used repeatedly, and the following definitions are intended to facilitate their understanding.

Axial direction: Wheel-bearing devices are often designed to be substantially cylindrical or as contoured hollow shapes in portions or regions. The axial direction roughly constitutes the cylindrical axis or the axis of the contoured hollow shape here and, in other words, only undergoes slight deviations from the cylindrical axis or the axis of the contoured hollow shape. In the wheel-bearing device, the axial direction can in particular substantially correspond to the width direction of the vehicle. Here, “axially inwards” refers to a direction which, proceeding from a vehicle comprising four wheels, points inwards from the center of the wheel, along an axle, towards the center of the vehicle or in the width direction of the vehicle. Here, “axially outwards” refers to a direction which, proceeding from a wheel of a vehicle comprising four wheels, points outwards from the center of the wheel, along an axle, or points in the width direction of the vehicle towards the outside of the vehicle.

Radial direction: On the basis of the axial direction as defined and described above, the radial direction refers to a direction that is substantially perpendicular to the axial direction.

Axial surface: An axial surface refers to a surface that extends substantially perpendicularly to an axis or to an axial direction. Here, an axial surface may extend substantially in a radial direction or may deviate slightly from a radial direction.

Radial plane: Similarly to the axial surface, a radial plane refers to a plane that extends substantially perpendicularly to an axis or to an axial direction. Here, a radial plane may extend substantially in a radial direction or may deviate slightly from a radial direction in a contoured manner.

Radial surface: A radial surface refers to a surface of a component that extends substantially perpendicularly to a radial direction, i.e., in other words, similarly to a cylinder surface. Here, a radial surface may extend substantially over a constant radius or may extend with a varying radius in a contoured manner.

Cross section: A cross section of a wheel-bearing device may be defined in various ways, and constitutes a sectional view or perspective in a particular orientation. A cross section may for example substantially be defined in an axial direction or along an axis of a wheel-bearing device, and this means a section of which the area is such that the axis or the axial direction of the wheel-bearing device lies therein. The present wheel-bearing device is generally described by a cross section in the axial direction or along the axis of the wheel-bearing device.

By way of example, the present wheel-bearing device is described on the basis of an outer-ring element which is configured to be connected to a vehicle body in order to thus be able to be mounted on the vehicle body in a rotationally fixed manner. By way of example, a wheel-hub element of the present wheel-bearing device is configured to be able to be rotatably mounted in the outer-ring element. Without any limitations, various rotary bearings or rolling bearings or sliding bearings, such as ball bearings, cylindrical-roller bearings, tapered-roller bearings and other bearings, can be used as rotary bearings or rolling bearings for mounting or rotatably mounting the wheel-hub element in the outer-ring element.

In alternative embodiments, the outer-ring element may be rotatably mounted on the vehicle body and the wheel-hub element may be mounted in the outer-ring element in a rotationally fixed manner.

In preferred embodiments of the wheel-bearing device, the elastomeric wheel-hub sealing structure may comprise a radial wheel-hub sealing lip, which extends between the radial wheel-hub sealing portion and the wheel-hub element substantially in a radial direction and contacts, in particular statically contacts, the wheel-hub element.

Advantageously, additionally arranging a radial wheel-hub sealing lip, which extends between the radial wheel-hub sealing portion and the wheel-hub element from the elastomeric wheel-hub sealing structure substantially in a radial direction and statically contacts the wheel-hub element, makes it possible to provide a preferred elastomeric wheel-hub sealing structure together with the axial wheel-hub sealing lip, which structure provides particularly reliable protection against water, dirt and other particles getting into an axial gap between the slinger-ring element and the wheel-hub element or wheel-hub end face. By protecting against dirt, water and other particles getting into the axial gap between the slinger-ring element and the wheel-hub element or wheel-hub end face, the slinger-ring element is advantageously prevented from being axially displaced axially inwards. Furthermore, preventing or avoiding the slinger-ring element being axially displaced inwards or inwards in the width direction of the vehicle makes it possible for the sealing surfaces, as provided by the slinger ring or the elastomeric wheel-hub sealing structure arranged on the slinger-ring element, to remain constant or substantially unchanged over the service life of the wheel-bearing device and thus for frictional losses not to change, in particular not to increase, over the service life of the wheel-bearing device, and for the sealing function of the wheel-bearing device not to lessen over the service life of the wheel-bearing device.

Furthermore, a radial wheel-hub sealing lip, which extends between the radial wheel-hub sealing portion and the wheel-hub element substantially in a radial direction and contacts, in particular statically contacts, the wheel-hub element, advantageously makes it possible for dirt, water or other particles that get into the axial gap between the slinger-ring element and the wheel-hub element past the axial wheel-hub sealing lip to still be caught. Furthermore, dirt, water and other particles that have penetrated into the axial gap and have been caught by the radial wheel-hub sealing lip can be thrown radially outwards by centrifugal action while the vehicle is being driven due to the rotation of the wheel-hub element and the resulting rotation of the elastomeric wheel-hub sealing structure. Dirt, water and other particles that have penetrated into the axial gap past the axial wheel-hub sealing lip can be expelled again past the axial wheel-hub sealing lip. For example, the axial wheel-hub sealing lip may be configured to elastically deform radially outwards, in particular to deform radially outwards in the region of the axial wheel-hub end face, when dirt, water and other particles that have got into the axial gap past the axial wheel-hub sealing lip are expelled by centrifugal action on dirt, water and other particles that have penetrated, such that a small and preferably local axial gap is temporarily formed between the axial wheel-hub sealing lip and the wheel-hub end face. By the axial wheel-hub sealing lip elastically deforming radially outwards and a preferably local axial gap being formed between the axial wheel-hub sealing lip and the wheel-hub end face, dirt, water and other particles that have penetrated can get out of the axial gap again, even after passing the axial wheel-hub sealing lip into the axial gap. Therefore, particularly preferred reliable sealing, and also a self-cleaning seal, can therefore be provided in an axial gap between the wheel-hub element and the slinger-ring element.

The above-described effect, made possible by a preferred embodiment of the elastomeric wheel-hub sealing structure comprising an axial wheel-hub sealing lip and a radial wheel-hub sealing lip, can be further enhanced. To do this, in exemplary embodiments, the axial wheel-hub sealing lip, which extends substantially axially towards the axial wheel-hub end face, may for example be configured to taper towards the axial wheel-hub end face in its axial extension in order to be slightly radially outwardly elastically deformable in the region of the static contact of the axial wheel-hub sealing lip. Furthermore, the axial wheel-hub sealing lip may for example be configured to extend substantially axially, with an increasing radius, towards the axial wheel-hub end face, as a result of which the axial wheel-hub sealing lip has a radially outwardly directed curvature in its substantially axial extension in order to be slightly radially outwardly elastically deformable. The above-mentioned exemplary configurations of the axial wheel-hub sealing lip can be used both individually and in combination, and also so as to be over either the entire periphery or portions of the periphery.

Furthermore, the preferred embodiment of the elastomeric wheel-hub sealing structure comprising an axial wheel-hub sealing lip and a radial wheel-hub sealing lip makes it possible, by arranging a radial wheel-hub sealing lip, for the axial wheel-hub sealing lip to be thinner than in an embodiment which does not comprise a radial wheel-hub sealing lip. A comparatively thinner axial wheel-hub sealing lip may advantageously make it possible for deformation of the wheel-hub flange or the inner axial wheel-hub end face towards the slinger-ring element to be mitigated under load, i.e. during driving, which advantageously prevents the slinger-ring element from being displaced towards the center of the vehicle over the service life of the wheel-bearing device. Therefore, the service life of the wheel-bearing device is advantageously increased and the radial expulsion of dirt, water and other particles outwards past the axial wheel-hub sealing lip is simplified.

Furthermore, since a radial wheel-hub sealing lip extends radially towards the wheel-hub element, it advantageously prevents thermally expanded air from escaping. In other words, a radially extending wheel-hub sealing lip advantageously makes it possible to withstand an overpressure in the bearing that develops due to heating during use, i.e. during driving.

In exemplary embodiments, the radial wheel-hub sealing lip extends axially towards the wheel-hub element so as to be directed towards the center of the vehicle with an inclination, meaning that thermally expanded air can be particularly advantageously prevented from escaping by the radial wheel-hub sealing lip being advantageously supported by the wheel-hub element by means of an axially outwardly directed overpressure in the bearing in the event of deformation. In other words, the radial wheel-hub sealing lip, which extends axially towards the center of the vehicle with an inclination, can particularly advantageously withstand an overpressure in the bearing. Preventing thermally expanded air from escaping from the bearing therefore prevents a negative pressure from developing when the bearing cools, i.e. after driving, meaning that dirt and water can be prevented from being drawn in after driving and particularly reliable sealing can be provided.

In particular by advantageously preventing thermally expanded air from escaping and by withstanding the overpressure in the bearing by means of a radial wheel-hub sealing lip, the axial wheel-hub sealing lip can be designed to be thinner compared with an embodiment which does not comprise a radial wheel-hub sealing lip, since overpressure due to thermally expanded air, as develops in the bearing during driving, does not reach the axial wheel-hub sealing lip.

In preferred embodiments of the wheel-bearing device, the wheel-hub sealing element or the elastomeric wheel-hub sealing structure may only comprise the axial wheel-hub sealing lip and the radial wheel-hub sealing lip for contacting the wheel-hub element, in particular for statically contacting the wheel-hub element. The wheel-hub sealing element or the elastomeric wheel-hub sealing structure may also be completely free of dynamically contacting sealing lips.

Advantageously, the wheel-bearing device, which comprises the elastomeric wheel-hub sealing structure, which only comprises the axial wheel-hub sealing lip and the radial wheel-hub sealing lip for statically contacting the wheel-hub element, makes it possible to provide a particularly simple structure which is easy to manufacture and to also provide advantageous protection against dirt, water and other particles penetrating into an axial gap between the slinger-ring element and the wheel hub with low frictional torque.

In preferred embodiments of the wheel-bearing device, a thickness ratio of the axial wheel-hub sealing lip to the radial wheel-hub sealing lip is in the range of from approximately 1.5 to approximately 4.0, preferably in the range of from approximately 1.7 to approximately 2.5, and particularly preferably in the range of from approximately 1.9 to approximately 2.1.

Advantageously, the above thickness ratios of the axial wheel-hub sealing lip to the radial wheel-hub sealing lip in the range of from approximately 1.5 to approximately 4.0 make it possible for particularly reliable protection against dirty water and other particles penetrating into the axial gap between the slinger-ring element and the wheel-hub element to be provided, and at the same time a thickness of the axial wheel-hub sealing lip can be reduced compared with an embodiment in which a radial wheel-hub sealing lip is not provided. This effect is further enhanced in the thickness-ratio ranges of from approximately 1.7 to approximately 2.5, and particularly preferably for the range of from approximately 1.9 to approximately 2.1, for the thickness of the axial wheel-hub sealing lip to the thickness of the radial wheel-hub sealing lip, and at the same time it is made possible to reduce the amount of material used for the axial wheel-hub sealing lip and the radial wheel-hub sealing lip, meaning that the manufacturing of the wheel-bearing device and the seal is further improved and simplified. Exemplary thicknesses of axial wheel-hub sealing lips may be in the range of from approximately 0.5 mm to approximately 5 mm. Exemplary thicknesses of radial wheel-hub sealing lips may be in the range of from approximately 0.8 mm to approximately 3 mm. When determining the thickness ratio, the average thicknesses of the sealing lips over the length of their extensions can be used. Preferably, the axial wheel-hub sealing lip and/or the radial wheel-hub sealing lip has a substantially constant thickness in its extension direction.

In alternative embodiments, the radial wheel-hub sealing lip may also be thicker than the axial wheel-hub sealing lip.

In preferred embodiments of the wheel-bearing devices, the elastomeric outer-ring sealing structure may comprise a radial outer-ring sealing lip, which extends between the radial outer-ring sealing portion and the cylindrical wheel-hub fastening portion substantially in a radial direction, and in particular contacts the cylindrical wheel-hub fastening portion. The radial outer-ring sealing lip can dynamically contact the cylindrical wheel-hub fastening portion.

Advantageously, additionally arranging a radial outer-ring sealing lip, which extends between the radial outer-ring sealing portion and the cylindrical wheel-hub fastening portion from the elastomeric outer-ring sealing structure substantially in a radial direction and in particular contacts, in particular dynamically contacts, the cylindrical wheel-hub fastening portion, makes it possible to provide a preferred elastomeric outer-ring sealing structure together with the axial outer-ring sealing lip, which structure provides particularly reliable protection against water, dirt and other particles getting into an axial gap between the outer-ring element and the wheel-hub element, and at the same time provides particularly reliable protection against grease getting out of the wheel-bearing device with low overall frictional torque.

Furthermore, additionally arranging a radial outer-ring sealing lip, which extends between the radial outer-ring sealing portion and the cylindrical wheel-hub fastening portion from the elastomeric outer-ring sealing structure substantially in a radial direction and in particular contacts, in particular dynamically contacts, the cylindrical wheel-hub fastening portion, makes it possible to advantageously prevent thermally expanded air from escaping. In other words, a radial outer-ring sealing lip which extends from the elastomeric outer-ring sealing structure substantially in a radial direction makes it possible for the radial outer-ring sealing lip to withstand an overpressure in the bearing that develops due to heating during use, i.e. during driving.

For example, the radial outer-ring sealing lip may be configured to be axially inwardly inclined in its substantially radial extension in order to advantageously counteract any possible escape of grease or lubricant. Furthermore, a radial outer-ring sealing lip, which is configured to be axially inwardly inclined in its substantially radial extension, makes it possible for thermally expanded air to be particularly advantageously prevented from escaping by the radial outer-ring sealing lip being advantageously supported by the cylindrical wheel-hub fastening portion by means of an axially outwardly directed overpressure in the bearing in the event of deformation. In other words, the radial outer-ring sealing lip, which is configured to be axially inwardly inclined in its substantially radial extension, particularly advantageously makes it possible to withstand an overpressure in the bearing. Preventing thermally expanded air from escaping from the bearing therefore prevents a negative pressure from developing when the bearing cools, i.e. after driving, meaning that dirt and water can be prevented from being drawn in after driving and particularly reliable sealing can be provided.

In particular by advantageously preventing thermally expanded air from escaping and by withstanding the overpressure in the bearing by means of a radial outer-ring sealing lip, the axial outer-ring sealing lip or the plurality of axial outer-ring sealing lips can be designed to be thinner compared with an embodiment which does not comprise a radial outer-ring sealing lip, since overpressure due to thermally expanded air, as develops in the bearing during driving, does not reach the one or more axial outer-ring sealing lips.

Optionally, the radial outer-ring sealing lip may be spaced apart from the cylindrical wheel-hub fastening portion, such that the radial outer-ring sealing lip does not contact the cylindrical wheel-hub fastening portion. By means of a radial outer-ring sealing lip which does not contact the cylindrical wheel-hub fastening portion, frictional losses can advantageously be reduced.

In preferred embodiments of the wheel-bearing device, the outer-ring sealing element or the elastomeric outer-ring sealing structure may only comprise the axial outer-ring sealing lip and the radial outer-ring sealing lip as sealing lips. In alternative embodiments of the wheel-bearing device, the outer-ring sealing element or the elastomeric outer-ring sealing structure may only comprise two axial outer-ring sealing lips and the radial outer-ring sealing lip as sealing lips. The outer-ring sealing element or the elastomeric outer-ring sealing structure may in particular be completely free of statically contacting sealing lips.

Advantageously, a wheel-bearing device comprising an elastomeric outer-ring sealing structure, which only comprises the axial outer-ring sealing lip or two axial outer-ring sealing lips and the radial outer-ring sealing lip as sealing lips, makes it possible to advantageously reduce or limit frictional losses. In the process, the overall assembly of the radial outer-ring sealing portion, the radial wheel-hub sealing portion, which is contacted by the axial outer-ring sealing lip, and the cylindrical wheel-hub fastening portion, which is sealed and contacted by the radial outer-ring sealing lip, provides particularly reliable sealing for protecting against dirt, water and other particles getting in and for protecting against grease getting out of a rolling bearing.

In preferred embodiments, a thickness ratio of the axial outer-ring sealing lip to the radial outer-ring sealing lip is in the range of from approximately 1.5 to approximately 4.0, preferably in the range of from approximately 1.7 to approximately 2.5, and particularly preferably in the range of from approximately 1.9 to approximately 2.1.

Advantageously, the above thickness ratios of the axial outer-ring sealing lip to the radial outer-ring sealing lip in the range of from approximately 1.5 to approximately 4.0 make it possible for particularly reliable protection against dirt, water and other particles getting into the axial gap between the outer-ring element and the wheel-hub element to be provided and for protection against grease getting out of a rolling bearing with low frictional torque to be provided, and at the same time a thickness of the axial outer-ring sealing lip can be reduced compared with an embodiment in which a radial outer-ring sealing lip is not provided. This effect is further enhanced in the thickness-ratio ranges of from approximately 1.7 to approximately 2.5, and particularly preferably for the range of from approximately 1.9 to approximately 2.1, for the thickness of the axial outer-ring sealing lip to the thickness of the radial outer-ring sealing lip, and at the same time it is made possible to reduce the amount of material used for the axial outer-ring sealing lip and the radial outer-ring sealing lip, meaning that the manufacture of the wheel-bearing device and the seal is further improved and simplified. In particular, a reduced thickness of the axial outer-ring sealing lip causes the outer-ring sealing lip to be compressed less heavily, meaning that frictional losses can be advantageously reduced. Exemplary thicknesses of axial outer-ring sealing lips may be in the range of from approximately 0.5 mm to approximately 3 mm. Exemplary thicknesses of radial outer-ring sealing lips may be in the range of from approximately 0.7 mm to approximately 1.5 mm. When determining the thickness ratio, the average thicknesses of the sealing lips over the length of their extensions can be used. Preferably, the axial outer-ring sealing lip and/or the radial outer-ring sealing lip has a substantially constant thickness in its extension direction.

In alternative embodiments, the radial outer-ring sealing lip may also be thicker than one axial outer-ring sealing lip or the plurality of axial outer-ring sealing lips.

In preferred embodiments of the wheel-bearing device, the outer-ring sealing element may comprise a collecting-lip structure at an axially outer end of the outer-ring element, which structure extends between the axially outer end of the outer-ring element and the wheel-hub end face, with a collecting lip which extends radially outwards in an inclined manner, in particular towards the side of the wheel-hub end face, being arranged on the collecting-lip structure, for example on a radially outer end portion of the collecting-lip structure, and with an axial outlet gap being configured between the collecting lip and the wheel-hub end face. More preferably, the axial outlet gap between the collecting lip and the wheel-hub end face may be configured such that it is ensured that particles pass out of the gap between the wheel-hub element and the outer-ring element in the radial direction.

Advantageously, a wheel-bearing device which comprises a collecting-lip structure makes it impossible for dirt or other particles to directly penetrate into the gap between the outer-ring element and the wheel-hub element, and in particular makes it impossible for dirt or other particles of a certain size to penetrate into the gap between the outer-ring element and the wheel-hub element at all.

More advantageously, a collecting lip that extends radially outwards in an inclined manner makes it possible for the collecting lip to slightly radially outwardly deform by expelling particles of dirt or water in the radial direction, which means that dirt, water and particles are not prevented from being expelled. An axial outlet gap can ensure that expulsion of dirt, water and particles caused by centrifugal action is always ensured.

In other preferred embodiments of the wheel-bearing device, the collecting-lip structure may comprise a substantially radially outwardly extending blocking lip, which extends radially beyond a radial outer-ring outer face. Particularly preferably, the blocking lip may be arranged on a radially outer end portion of the collecting-lip structure in this case. More preferably, the blocking lip may extend radially outwards further than a collecting lip.

Advantageously, a substantially radially outwardly extending blocking lip, which extends radially beyond a radial outer-ring outer face, makes it impossible for dirt particles of a certain size to be deposited on the collecting lip, and instead said dirt particles are kept away from the collecting lip by the substantially radially extending blocking lip. Therefore, a substantially radially extending blocking lip advantageously makes it possible to maintain the function of the collecting lip for comparatively small pieces of dirt, particles and amounts of water and also to extend the service life of the collecting lip, which in turn can advantageously maintain the sealing function of a wheel-bearing device over a long service life.

In other preferred embodiments of the wheel-bearing device, the slinger-ring element may comprise a wheel-hub labyrinth portion, which is arranged radially outside the cylindrical wheel-hub fastening portion and extends from the radial wheel-hub sealing portion substantially axially towards the radial outer-ring sealing portion.

Advantageously, by means of a wheel-hub labyrinth portion, which is arranged radially outside the cylindrical wheel-hub fastening portion and extends from the radial wheel-hub sealing portion substantially axially towards the radial outer-ring sealing portion, an advantageous sealing labyrinth is provided which additionally makes it difficult for dirt, water and other particles to get into the rolling bearing and makes it difficult for grease to get out of the rolling bearing, as a result of which the load on one or more sealing lips, which are provided by the outer-ring sealing element, is relieved. Since the load on the sealing lips or on one or more sealing lips, which are provided by the outer-ring sealing element, is relieved, these one or more sealing lips can be thinner, which means that the production and manufacture of the elastomeric outer-ring sealing structure can be simplified and also can be carried out more cost-effectively. At the same time, an advantageous sealing labyrinth, as provided by the above-described wheel-hub labyrinth portion, means that just a few sealing lips, in particular axial outer-ring sealing lips and radial outer-ring sealing lips, are required. Both a thinner configuration of the sealing lips and a lower number of sealing lips advantageously makes it possible to reduce frictional losses. The wheel-hub labyrinth portion may extend substantially in parallel with the wheel-hub fastening portion and/or substantially in parallel with the outer-ring fastening portion of the insertion element.

In exemplary embodiments, the slinger-ring element may be configured substantially C-shaped. For example, the C-shaped slinger-ring element may comprise a cylindrical wheel-hub fastening portion, which is connected to the cylindrical wheel-hub portion, a radial wheel-hub sealing portion, which extends radially outwards or away from the cylindrical wheel-hub fastening portion substantially in the radial direction, and a wheel-hub labyrinth portion, which is arranged radially outside the cylindrical wheel-hub fastening portion and extends from the radial wheel-hub sealing portion substantially axially towards the radial outer-ring sealing portion.

Optionally, said portions of the slinger ring, namely the cylindrical wheel-hub portion, the radial wheel-hub sealing portion and the wheel-hub labyrinth portion, may be interconnected by inclined transitions.

In exemplary preferred embodiments, the slinger-ring element may comprise an inclined inner wheel-hub transition portion, which connects the cylindrical wheel-hub fastening portion to the radial wheel-hub sealing portion and extends axially outwards with an increasing radius. By the inclined inner wheel-hub transition portion extending axially outwards with an increasing radius, particularly reliable sealing can be provided, with a transition region being provided between the inclined inner wheel-hub sealing transition portion and the radial wheel-hub sealing portion, which is close to a contact region of the axial outer-ring sealing lip on the radial wheel-hub sealing portion. If there are large amounts of dirt, water or other particles be present on the axial outer-ring sealing lip, the axial outer-ring sealing lip, due to its proximity to the inclined inner wheel-hub sealing transition portion, can come to rest on a portion of the inclined inner wheel-hub sealing transition portion, meaning that dirt, water or other particles are advantageously prevented from being let in towards the rolling bearing. By means of the above-described reliable sealing against dirt, water or other particles being let in towards the rolling bearing, by means of the inclined inner wheel-hub sealing transition portion, additional sealing lips can in particular advantageously be omitted and, furthermore, the axial outer-ring sealing lip can be configured to be thinner, meaning that frictional losses can advantageously be reduced.

In alternative embodiments, the slinger-ring element may be substantially L-shaped, the slinger-ring element not comprising a wheel-hub labyrinth portion, for example, and this makes it possible to provide a sealing labyrinth that is simple to produce.

In other preferred embodiments of the wheel-bearing device, the radial outer-ring sealing portion may be configured in portions, with a first radial outer-ring sealing segment extending axially further inwards than a second radial outer-ring sealing segment, the first radial outer-ring sealing segment being arranged radially outside the second radial outer-ring sealing segment, the first radial outer-ring sealing segment being connected to the second radial outer-ring sealing segment by an outer-ring sealing transition portion, such that the outer-ring element comprises an axially inwardly recessed peripheral cavity and the wheel-hub labyrinth portion extends as far as the cavity and preferably extends into the cavity.

Advantageously, a configuration of the radial outer-ring sealing portion in portions by means of a first radial outer-ring sealing segment and a second radial outer-ring sealing segment, with the first radial outer-ring sealing segment extending axially further inwards than a second radial outer-ring sealing segment, and the first radial outer-ring sealing segment being arranged radially outside the second radial outer-ring sealing segment, makes it possible for a sealing labyrinth effect to be further improved, as a result of which fewer sealing lips, in particular axial outer-ring sealing lips, are again required for reliable sealing and the arranged sealing lips, in particular outer-ring sealing lips, can again be configured to be thinner and are configured to be less stiff, in order to again reduce frictional losses.

Advantageously again, an inwardly recessed peripheral cavity, with a wheel-hub labyrinth portion extending as far as the cavity and particularly preferably extending into the inwardly recessed peripheral cavity, makes it possible for a sealing labyrinth to be provided which allows for particularly reliable sealing against dirt, water and other particles getting into the rolling bearing and against grease getting out of the rolling bearing. Advantageously again, due to the reliable sealing by the inwardly recessed cavity and the wheel-hub labyrinth portion, which extends as far as the cavity and optionally into the cavity, fewer sealing lips are used and/or the sealing lips, as provided by the outer-ring sealing structure, are configured to be thinner, in order to advantageously reduce frictional losses.

Advantageously again, a configuration of the radial outer-ring sealing portion in portions as a first and a second radial outer-ring sealing segment, which extend substantially radially inwards so as to be axially offset from one another, makes it possible for the elastomeric outer-ring sealing structure to be arranged radially inwards close to the cylindrical wheel-hub fastening portion, irrespective of the contour or geometry of the wheel-hub sealing element. By means of an elastomeric outer-ring sealing structure arranged radially close to the cylindrical wheel-hub fastening portion, the outer-ring sealing structure may advantageously be pressed against the wheel-hub sealing element, i.e. in particular against the radial wheel-hub sealing portion and/or the cylindrical wheel-hub fastening portion, which results in particularly reliable sealing while production is simplified at the same time by less elastomeric material being used.

In other exemplary embodiments of the wheel-bearing device, the outer-ring sealing element may comprise more than two radial outer-ring sealing segments, which may extend axially further inwards and axially further outwards substantially in the radial direction in any order so as to configure one or more axially inwardly recessed peripheral cavities and to therefore provide a particularly preferred sealing labyrinth.

By way of example, a wheel-hub labyrinth portion or a plurality of wheel-hub labyrinth portions may extend as far as a cavity or the plurality of cavities and may optionally extend into the cavity or the plurality of cavities. By way of example, the one wheel-hub labyrinth portion or the plurality of wheel-hub labyrinth portions may extend from the radial wheel-hub sealing portion, and optionally may extend substantially axially or in a substantially contoured manner, in order to provide a particularly preferred sealing labyrinth.

In another preferred embodiment of the wheel-bearing device, the wheel-bearing device may comprise the following:
an axial inlet gap, which is defined as an axial distance, in particular the smallest possible axial distance, between the wheel-hub end face and the outer-ring sealing element,
an axial collecting gap, which is defined as an axial distance, in particular the smallest possible axial distance, between the wheel-hub end face and a radially outer end of the elastomeric wheel-hub sealing structure,
a radial collecting height, which is defined as a radial distance, in particular the smallest possible radial distance, between a radially outer face of the axial wheel-hub sealing lip and the radially outer end of the elastomeric wheel-hub sealing structure,
   wherein the radial collecting height is greater than or equal to the axial collecting gap and/or the axial inlet gap is smaller than or equal to the axial collecting gap.

Advantageously, by an axial inlet gap being smaller than or equal to an axial collecting gap, penetrating dirt, penetrating water or other penetrating particles cannot directly get into the sealing labyrinth to the sealing lips, as provided by the outer-ring sealing structure, but instead first reaches the axial wheel-hub sealing lip, with this dirt, these particles or this water being able to be expelled again by centrifugal action while a vehicle is being driven.

Furthermore, a radial collecting height which is greater than an axial collecting gap makes it possible for penetrating dirt, penetrating particles or penetrating water to be collected by the axial wheel-hub sealing lip without even just a small amount of dirt, water or other particles being let into the sealing labyrinth. Therefore, a radial collecting height which is greater than an axial collecting gap advantageously ensures that the majority of the dirt, water and other particles that reach the axial wheel-hub sealing lip can be expelled by centrifugal action.

In other words, the radial collecting height may be defined as a radial distance, in particular the smallest possible radial distance, along the elastomeric wheel-hub sealing structure between a radially outer face of the attachment of the axial wheel-hub sealing lip on the elastomeric wheel-hub sealing structure and the radially outer end of the slinger-ring element.

In exemplary embodiments, the elastomeric wheel-hub sealing structure may comprise or consist of rubber-elastic materials. The elastomeric wheel-hub sealing structure may optionally be arranged on the slinger-ring element by vulcanization or other methods, such as adhesion.

In exemplary embodiments, the elastomeric outer-ring sealing structure may comprise or consist of rubber-elastic materials. The elastomeric outer-ring sealing structure may optionally be arranged on the insertion element by vulcanization or other methods, such as adhesion.

In exemplary embodiments, the substantially rigid slinger-ring element may be a metal slinger-ring element, but is not limited thereto. Therefore, the slinger-ring element may for example comprise or consist of various metals, such as steels or aluminum, or may also comprise or consist of other materials such as polymers. The slinger-ring element may for example be connected to or arranged on the cylindrical wheel-hub portion by being pressed on, screwed on, or other variants, such as by means of circlips.

In exemplary embodiments, the substantially rigid insertion element may be a metal insertion element, but is not limited thereto. Therefore, the insertion element may for example comprise or consist of various metals, such as steels or aluminum, or may also comprise or consist of other materials such as polymers. The insertion element may for example be connected to or arranged on the radial outer-ring inner face by being pressed in, screwed in, or other variants, such as by means of circlips.

In the following, embodiments of the invention are described in greater detail on the basis of the accompanying figures. It is clear that the present invention is not limited to these embodiments, and that individual features of the embodiments in the context of the accompanying claims can be combined to form other embodiments.

In the drawings:

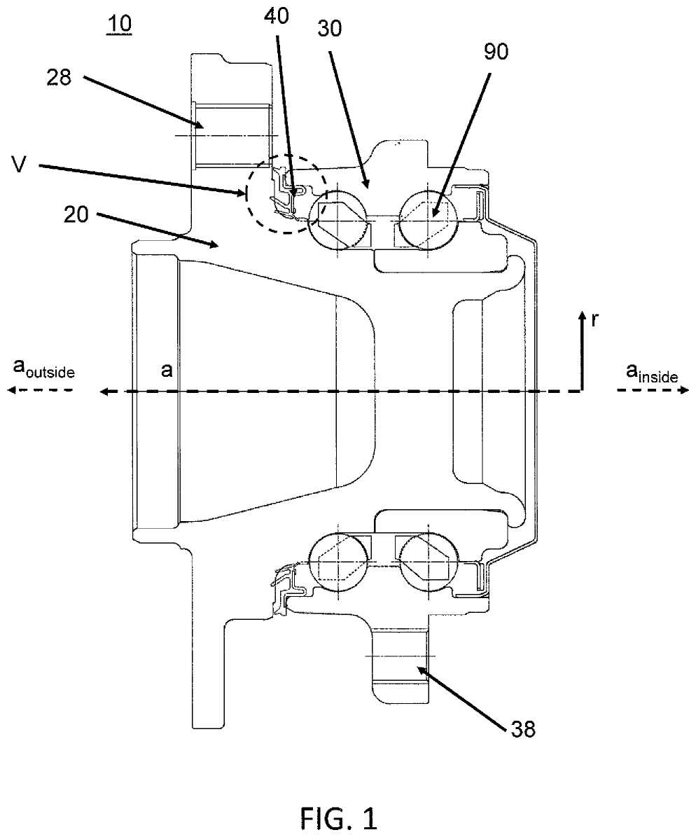

FIG. 1 is a sectional view of a wheel-bearing device;

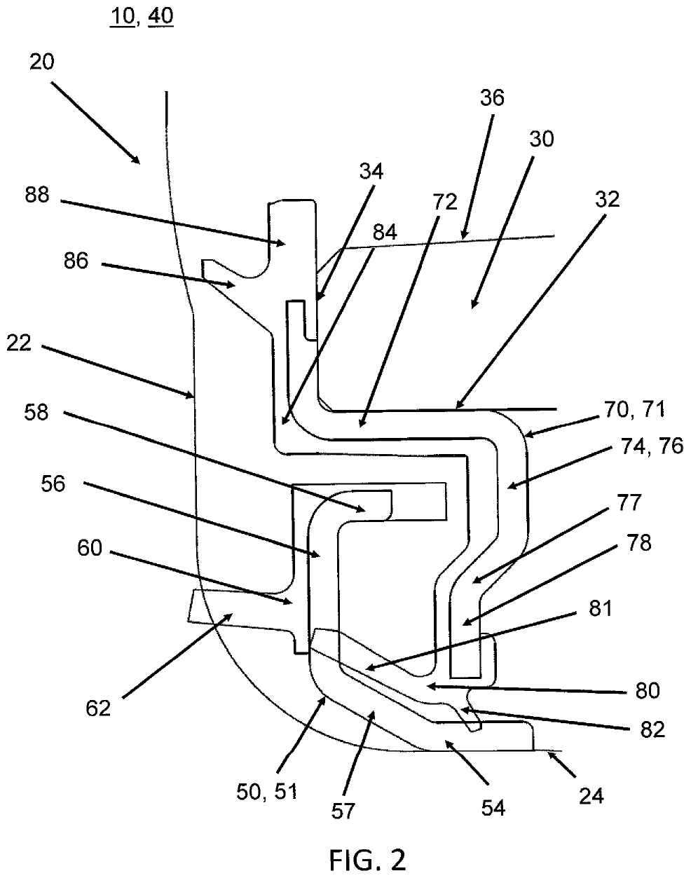

FIG. 2 is a sectional view of a sealing device of a wheel-bearing device;

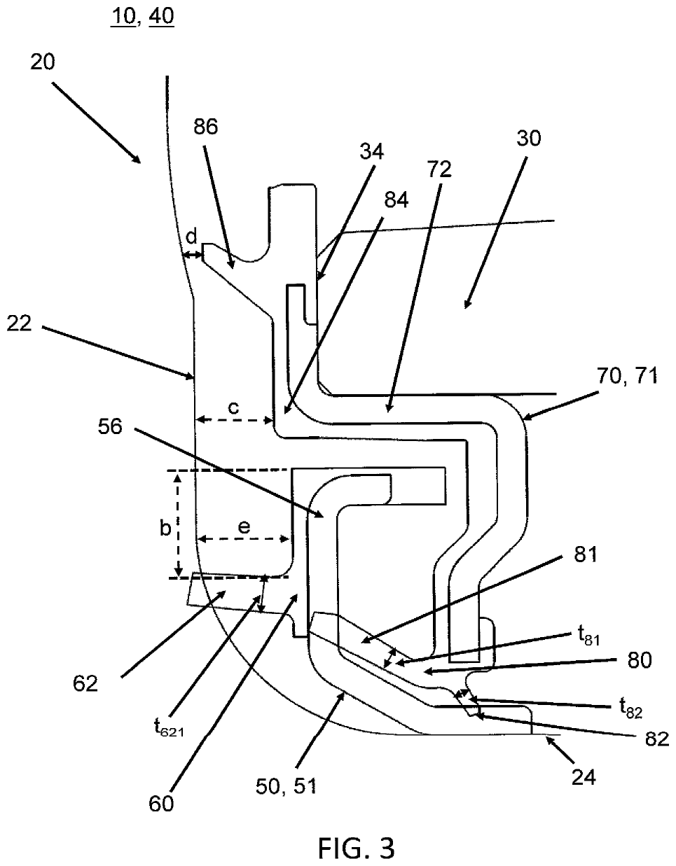

FIG. 3 is another sectional view of a sealing device of a wheel-bearing device;

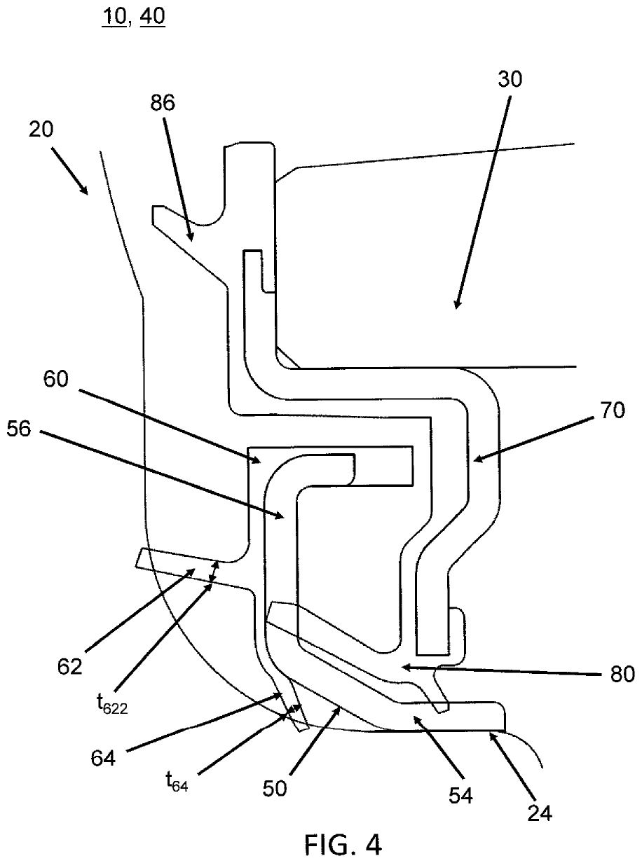

FIG. 4 is another sectional view of a sealing device of a wheel-bearing device;

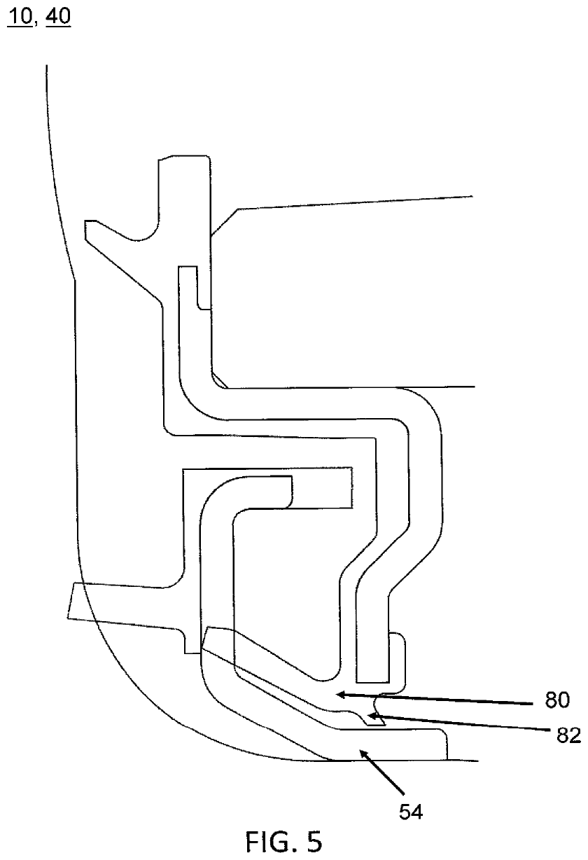

FIG. 5 is another sectional view of a sealing device of a wheel-bearing device;

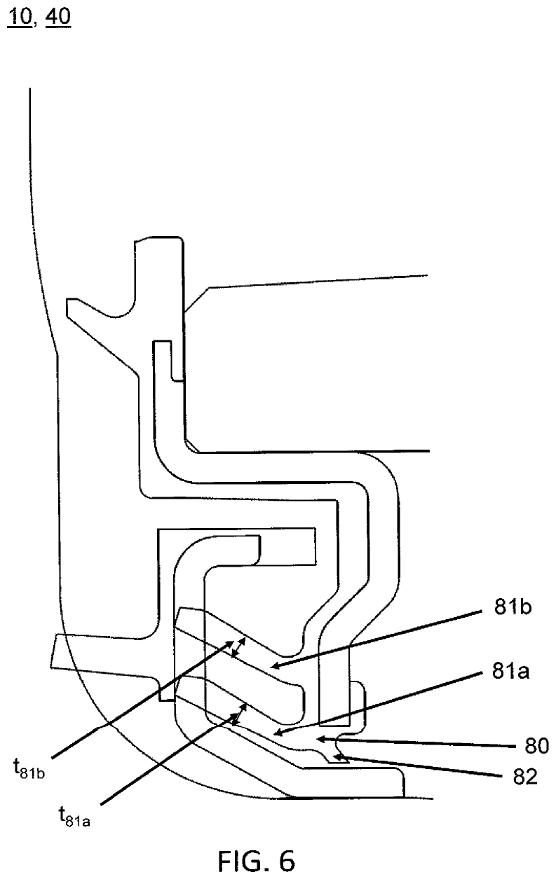

FIG. 6 is another sectional view of a sealing device of a wheel-bearing device;

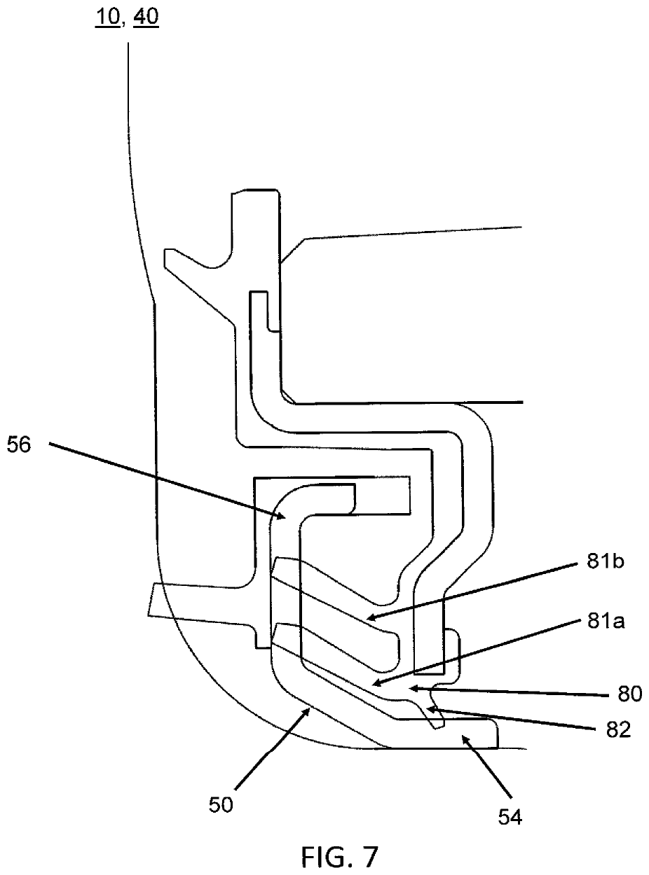

FIG. 7 is another sectional view of a sealing device of a wheel-bearing device; and

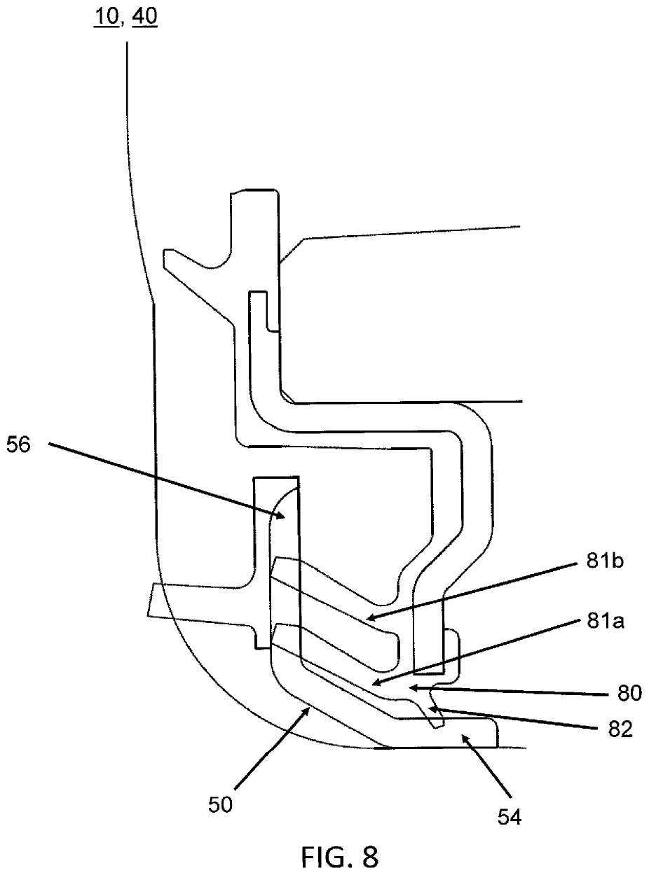

FIG. 8 is another sectional view of a sealing device of a wheel-bearing device.

FIG. 1 is a sectional view of a wheel-bearing device 10 on the basis of a cross section along an axis a of the wheel-bearing device 10. In this figure, the wheel-bearing device 10 comprises an outer-ring element 30 for attachment to a vehicle body, for example by means of an outer-ring fastening portion 38, and a wheel-hub element 20 for connection to a wheel, for example by means of one or more wheel-fastening portions 28. By way of example, the wheel-hub element 20 is rotatably mounted in the outer-ring element 30 by a rolling bearing 90, with the rolling bearing 90, as shown in FIG. 1 by way of example, being able to be arranged on an inner peripheral side of the outer-ring element 30 and also being able to be arranged on at least one portion of an outer peripheral side of the wheel-hub element 20. A sealing device 40 is arranged in a gap between the outer-ring element 30 and the wheel-hub element 20, with a magnification region V being marked on FIG. 1, which includes the sealing device 40 and is described in greater detail in the remaining figures, FIG. 2 to 7, by way of example.

Furthermore, FIG. 1 shows an axis a of the wheel-bearing device 10 or an axial direction a of the wheel-bearing device 10, which extends from right to left in FIG. 1. Since the wheel of a vehicle can be mounted on the wheel-hub element 20, in particular on the wheel-hub fastening portion 28, the axial direction a corresponds to a width direction of the vehicle from the center of the vehicle towards the outside of the vehicle. In particular, FIG. 1 shows the axial direction inwards or the direction axially inwards by a_{inwards}, and shows the axial direction outwards or the direction axially outwards by a_{outwards}. The radial direction r extends substantially radially, i.e. substantially perpendicularly or normally to the axial direction a. Here, “radially outwards” describes a direction proceeding from the axial direction or axis a, i.e. with an increasing radius. By contrast, “radially inwards” describes a direction towards the axial direction or axis a, i.e. with a decreasing radius.

The orientation in the remaining figures, FIG. 2 to 7, corresponds to the orientation in FIG. 1, and therefore the axial direction a in FIG. 2 to 7 likewise extends from right to left and the direction axially inwards a_{inwards} extends from left to right.

FIG. 2 shows an exemplary embodiment of a wheel-bearing device 10 according to the invention, in particular a sealing device 40 for a wheel-bearing device 10, which reproduces various features which can be combined with one another in any way.

Therefore, by way of example, FIG. 2 shows a wheel-hub sealing element 50, which comprises a substantially rigid slinger-ring element 51, in particular a metal slinger-ring element 51, and comprises an elastomeric wheel-hub sealing structure 60 arranged on the slinger-ring element 51. The slinger-ring element 51 comprises a cylindrical wheel-hub fastening portion 54, which is configured to be connected to a cylindrical wheel-hub portion 24, with it being possible for the connection of the cylindrical wheel-hub fastening portion 54 to the cylindrical wheel-hub portion 24 to be produced by being pressed on, screwed on, or other methods. The wheel-hub sealing element 50 further comprises a radial wheel-hub sealing portion 56, which extends substantially radially, with it being possible for the radial wheel-hub sealing portion 56 to optionally extend directly from the cylindrical wheel-hub fastening portion 54 or to be connected to the cylindrical wheel-hub fastening portion 54 via an inclined inner wheel-hub sealing transition portion 57. As shown by way of example in FIG. 2, an inclined inner wheel-hub sealing transition portion 57 may extend axially outwards from the cylindrical wheel-hub fastening portion 54 with an increasing radius.

The elastomeric wheel-hub sealing structure 60, as shown in FIG. 2, may be arranged on the wheel-hub sealing element 50 or on the slinger-ring element 51 in any way and may cover or extend over any faces of the slinger-ring element 51. In preferred embodiments, as shown in FIG. 2, the radially inner face of the cylindrical wheel-hub fastening portion may be free of the elastomeric wheel-hub sealing structure 60, in order to allow a secure and rigid arrangement of the wheel-hub sealing element 50 on the wheel hub 20.

As shown in FIG. 2, the elastomeric wheel-hub sealing structure 60 comprises an axial wheel-hub sealing lip 62, which extends substantially axially outwards and contacts an inner axial wheel-hub end face 22 of the wheel-hub element 20. The inner axial wheel-hub end face 22 describes a face of the wheel-hub element 20 that is arranged axially on the inside and delimits a gap between the wheel-hub element 20 and the outer-ring element 30 axially outwards. In other words, the axial wheel-hub end face 22 faces the outer-ring element 30. The axial wheel-hub end face 22 may extend or lead into a cylindrical portion of the wheel-hub element 20, in particular the cylindrical wheel-hub portion 24, in a contoured manner or so as to follow a curvature.

Since the axial wheel-hub sealing lip 62 is arranged on the slinger-ring element 51 of the wheel-hub sealing element 50, wherein the slinger-ring element 51 the cylindrical wheel-hub fastening portion 54, which is connected to the cylindrical wheel-hub portion 24, the radial wheel-hub sealing lip 62 can rotate at the same speed as the wheel-hub element 20 while a vehicle is being driven. As a result, the contact of the axial wheel-hub sealing lip 62 on the inner axial wheel-hub end face 22 can be static contact or static sealing, with there being no friction caused by driving. Furthermore, by the wheel-hub sealing lip 62 rotating, dirt, water and other particles that reach the axial wheel-hub sealing lip 62 can be expelled therefrom by centrifugal action, i.e. can be expelled radially outwards through an outlet gap d (see also FIG. 3) in the sealing device 40. By expelling dirt, water and other particles by the axial wheel-hub sealing lip 62 rotating during driving, the sealing device 40 can effectively and advantageously protect the wheel-bearing device 10 against dirt, water and other particles getting in, in particular getting to the rolling bearing 90.

As shown by way of example in FIG. 2, the slinger-ring element 51 may comprise a wheel-hub labyrinth portion 58, which extends substantially axially inwards from the radial wheel-hub sealing portion 56. The wheel-hub labyrinth portion 58 elongates the path of dirt, water and other particles to one or more sealing lips, as provided by the outer-ring sealing element 70, and therefore makes it difficult for dirt, water and other particles to reach one or more sealing lips, as provided by the outer-ring sealing element 70, such that a wheel-hub labyrinth portion 58 can improve the sealing function of the sealing device 40. Furthermore, the wheel-hub labyrinth portion 58 may advantageously make it difficult for grease to get out of the rolling bearing.

Since the sealing function of the sealing device 40 can be improved by means of the wheel-hub labyrinth portion 58, the sealing device 40 can also be configured to have a reduced number of sealing lips, in particular on axial and radial outer-ring sealing lips 81, 82, as provided by the outer-ring sealing element 70, for example, meaning that frictional losses that occur in the wheel-bearing device 10 during driving can be reduced.

Furthermore, by way of example, FIG. 2 shows an outer-ring sealing element 70, which comprises a substantially rigid insertion element 71, optionally in particular a metal insertion element 71, and comprises an outer-ring sealing structure 80 arranged on the insertion element 71. The insertion element 71 comprises a cylindrical outer-ring fastening portion 72, which is configured to be connected to a radial outer-ring inner face 32, with it being possible for the connection of the cylindrical outer-ring fastening portion 72 to the radial outer-ring inner face 32 to be produced by being pressed in, screwed in, or other methods or processes. The outer-ring sealing element 70, in particular the insertion element 71, further comprises a radial outer-ring sealing portion 74, which extends substantially radially inwards from the cylindrical outer-ring fastening portion 72. The elastomeric outer-ring sealing structure 80, which is arranged on the insertion element 71, comprises at least one outer-ring sealing lip 81, which extends substantially axially outwards from the radial outer-ring sealing portion 74 to the radial wheel-hub sealing portion 56.

If the outer-ring element 30 is mounted on the vehicle body in a rotationally fixed manner and the wheel-hub element 20 is rotatably mounted and rotates with the wheel of a vehicle when it is being driven, there is a relative movement, rotating about the wheel-bearing-device axis a, between the wheel-hub sealing element 50 and the outer-ring sealing element 70 during driving. By arranging the radial wheel-hub sealing portion 56 on the wheel-hub sealing element 50 and arranging the at least one axial outer-ring sealing lip 81 on the outer-ring sealing element 70, there is likewise a rotating relative movement about the axis a of the wheel-bearing device 10 between the radial wheel-hub sealing portion 56 and the at least one axial outer-ring sealing lip 81 during driving. FIG. 2 shows an axial outer-ring sealing lip 81 by way of example and also shows said outer-ring sealing lip projecting into the radial wheel-hub sealing portion 56. This view is schematic and is intended to show that at least one axial outer-ring sealing lip 81 contacts the radial wheel-hub sealing portion 56, in particular contacts the wheel-hub sealing portion 56 by specifically pressing on an elastomeric portion. By means of the rotating relative movement between the radial wheel-hub sealing portion 56 and the at least one outer-ring sealing lip 81, the contact surface of the at least one outer-ring sealing lip 81 is configured as an abrasive surface or frictional surface. The contact between the radial wheel-hub sealing portion 56 and the at least one outer-ring sealing lip 81 is also referred to as dynamic contact or dynamic sealing owing to the rotating relative movement.

As shown in FIG. 2, the axial outer-ring sealing lip 81 may in particular extend from a region of a radially inner end of the radial outer-ring sealing portion 74.

As also indicated in FIG. 2, the axial outer-ring sealing lip 81 may extend substantially axially outwards, substantially in parallel with an inclined inner wheel-hub sealing transition portion 57 of the wheel-hub sealing element 50, or axially outwards with an increasing radius. In preferred embodiments, the at least one axial outer-ring sealing lip 81 may contact the radial wheel-hub sealing portion 56 and may extend further radially outwards so as to follow the extension of the radial wheel-hub sealing portion 56 after contacting the radial wheel-hub sealing portion 56, and in particular may abut the radial wheel-hub sealing portion 56 when extending further radially outwards.

As shown in FIG. 2, the radial outer-ring sealing portion 74 may be configured in portions, with the portions extending substantially radially but at different axial heights of the axis a of the wheel-bearing device 10. For example, the radial outer-ring sealing portion 74 may comprise a first radial outer-ring sealing segment 76 and a second radial outer-ring sealing segment 78. In alternative embodiments, the radial outer-ring sealing portion 74 may comprise three radial outer-ring sealing segments, which extend substantially radially but at different axial heights of the axis a of the wheel-bearing device 10. In other alternative embodiments, the radial outer-ring sealing portion 74 may comprise more than three, in other words any number of, for example four, five or six radial outer-ring sealing segments, which extend substantially radially in succession in the radial direction at different axial heights of the axis a of the wheel-bearing device 10. By configuring the radial outer-ring sealing portion 74 in portions, a wheel-bearing device 10 or a sealing device 40 may be configured to have a sealing labyrinth, which makes it difficult for dirt, water and other particles to reach the sealing lips, in particular the at least one axial outer-ring sealing lip 81, which means that particularly advantageous and reliable sealing is provided.

FIG. 2 shows, by way of example, that a first radial outer-ring sealing segment 76 and a second radial outer-ring sealing segment 78 can extend substantially radially, with the first radial outer-ring sealing segment 76 extending axially further inwards than the second radial outer-ring sealing segment 78. The first radial outer-ring sealing segment 76 and the second radial outer-ring sealing segment 78 may be interconnected by a transition portion 77, which optionally extends in an inclined manner or in a substantially axial direction.

By means of the above-described configuration in portions of the radial outer-ring sealing portion 74 as a first radial outer-ring sealing segment 76 and a second radial outer-ring sealing segment 78, with the first radial outer-ring sealing segment 76 extending axially further inwards than the second radial outer-ring sealing segment 78, the outer-ring element 30 is configured to have a peripheral cavity which is recessed axially inwards. In other words, the outer-ring element 30 may comprise an axially inwardly recessed peripheral cavity. The axially inwardly recessed peripheral cavity may preferably be produced by the configuration in portions of the radial outer-ring sealing portion 74 as a first radial outer-ring sealing segment 76 and a second radial outer-ring sealing segment 78, which each extend in a substantially radial direction, with the first radial outer-ring sealing segment 76 extending axially further inwards than the second radial outer-ring sealing segment 78, and with the first radial outer-ring sealing segment 76 being arranged radially outside the second radial outer-ring sealing segment 78, by way of example.

Furthermore, FIG. 2 shows that the wheel-hub sealing element 50 or the slinger-ring element 51 may comprise a wheel-hub labyrinth portion 58, which extends substantially axially inwards from the radial wheel-hub sealing portion 56.

Preferably, and as shown in FIG. 2, a wheel-hub labyrinth portion 58 may extend towards the axially inwardly recessed peripheral cavity, and particularly preferably extends into the cavity at least in part. By the wheel-hub labyrinth portion 58 extending towards the cavity or into the cavity in part, the wheel-bearing device 10 or the sealing device 40 can be configured to have a particularly preferred sealing labyrinth which provides reliable sealing or a reliable sealing function, since it is made difficult for dirt, water and other particles to get in.

Furthermore, FIG. 2 shows, by way of example, that the elastomeric outer-ring sealing structure 80 may comprise a radial outer-ring sealing lip 82, with the radial outer-ring sealing lip 82 being able to be configured to optionally contact, in particular dynamically contact, the cylindrical wheel-hub fastening portion 54.

Embodiments of the wheel-bearing device 10 which comprise a radial outer-ring sealing lip 82 that contacts the cylindrical wheel-hub fastening portion 54 allow for particularly reliable sealing in order to protect against dirt getting into the rolling bearing 90 or to protect against grease getting out of the rolling bearing 90.

In exemplary embodiments, and as shown in FIG. 2, the radial outer-ring sealing lip 82 may extend axially inwards with a decreasing radius from an end portion of the radial outer-ring sealing element 74 in an inclined manner, as a result of which the radial outer-ring sealing lip 82 can subsequently abut the cylindrical wheel-hub fastening portion 54 axially inwards, meaning that advantageous sealing against grease getting out of the rolling bearing can be provided, since it is difficult for the radial outer-ring sealing lip 82 to be pushed open axially outwards.

FIG. 2 also shows that the elastomeric outer-ring sealing structure 80 may comprise a collecting-lip structure 84 on an axially outer end of the outer-ring element 30, which structure extends between the axially outer end 34 of the outer-ring element 30 and the axial wheel-hub end face 22, preferably extends along the axially outer end 34 of the outer-ring element. By way of example, the collecting-lip structure 84 may comprise a collecting lip 86, which optionally extends substantially axially outwards or so as to be inclined radially outwards, i.e. axially outwards with an increasing radius. Preferably, an axial outlet gap d is configured between the collecting lip 86 and the axial wheel-hub end face 22 (as also shown in FIG. 3), as a result of which it is possible for dirt, water and other particles to get out of the gap between the wheel-hub element 20 and the outer-ring element 30 in the radial direction, for example by centrifugal action. For example, the collecting lip 86 may be arranged on a radially outer end portion of the collecting-lip structure 84. Alternatively, the collecting lip 86 may be arranged on a central portion of the collecting-lip structure 84 or a radially inner portion of the collecting-lip structure 84. The collecting lip 86 may advantageously prevent water, dirt and other particles from getting into or being let into the gap between the wheel-hub element 20 and the outer-ring element 30, and thus improves the sealing function of the wheel-bearing device 10 or the sealing device 40. Furthermore, a preferred extension of the collecting lip 86, namely an inclined or axially outward extension with an increasing radius having an axial outlet gap d to the axial wheel-hub end face 22, encourages the escape of dirt, water and other particles which reach the axial wheel-hub sealing lip 62 and are radially outwardly expelled by centrifugal action during driving.

Furthermore, FIG. 2 shows that the elastomeric outer-ring sealing structure 80 may comprise a blocking lip 88, which extends substantially radially outwards and preferably extends beyond a radial outer-ring outer face 36. The blocking lip 88 advantageously prevents large particles from directly reaching the collecting lip 86, meaning that the service life and functionality of the collecting lip 86 is extended, and therefore reliable sealing of the wheel-bearing device 10 can also be ensured.

The exemplary embodiment as shown in FIG. 2 therefore has various features for providing a wheel-bearing device 10 or a sealing device 40 for a wheel-bearing device 10 that is reliable and at the same time has low frictional losses. The above-described features, as explained on the basis of FIG. 2, can be combined and/or omitted as desired in the context of the accompanying claims.

FIG. 3 shows the same exemplary embodiment of a wheel-bearing device 10, in particular a sealing device 40 for a wheel-bearing device 10, as FIG. 2, and further configurations will be explained on the basis of FIG. 3.

FIG. 3 thus in particular shows gap dimensions and distances b, c, d and e, as well as thicknesses t of the exemplary sealing lips 62, 81, 82.

As already described with reference to FIG. 2, the collecting lip 86 is preferably configured to have an axial outlet gap d to the axial wheel-hub end face 22, which ensures that dirt, water and other particles that reach the axial wheel-hub sealing lip 62 are expelled where necessary.

Furthermore, the wheel-bearing device 10, as shown in FIG. 3, preferably has an axial inlet gap c, which is defined as an axial distance between the axial wheel-hub end face 22 and the elastomeric outer-ring sealing element 80. The axial inlet gap c may in particular be defined as the smallest possible axial distance between the axial wheel-hub end face 22 and the outer-ring sealing element 80, with a collecting lip 86 that may be arranged there not being taken into consideration for the definition of the axial inlet gap c. In other words, the axial inlet gap c may in particular be defined as an axial distance, in particular as the smallest possible axial distance, between the axial wheel-hub end face 22 and an axially outer extension of the elastomeric outer-ring sealing element 80, which is arranged on an axially outer end of the cylindrical outer-ring fastening portion 72 of the outer-ring sealing element 70.

Furthermore, the wheel-bearing device 10, as shown in FIG. 3, preferably has an axial collecting gap e, which is defined as an axial distance between the axial wheel-hub end face 22 and a radially outer end of the elastomeric wheel-hub sealing structure 60. The axial collecting gap e may in particular be defined as the smallest possible axial distance between the axial wheel-hub end face 22 and the radially outer end of the elastomeric wheel-hub sealing structure 60, with an axial wheel-hub sealing lip 62 arranged there not being taken into consideration for the definition of the axial collecting gap e. In other words, the axial collecting gape may be defined as an axial distance, in particular as the smallest possible axial distance, between the axial wheel-hub end face 22 and an axially outer extension of the elastomeric wheel-hub sealing structure 60, which is arranged on a radially outer end of the radial wheel-hub sealing portion 56.

Furthermore, the wheel-bearing device 10, as shown in FIG. 3, preferably has a radial collecting height b, which is defined as a radial distance between a radially outer face of the axial wheel-hub sealing lip 62 and the radially outer end of the elastomeric wheel-hub sealing structure 60. The radial collecting height b may in particular be defined as the smallest possible radial distance between a radially outer face of the axial wheel-hub sealing lip 62 and the radially outer end of the elastomeric wheel-hub sealing structure 60, with a possible extension of the wheel-hub sealing lip 62 along the axial wheel-hub end face not being taken into consideration for the definition of the radial collecting height b. In other words, the axial collecting height b may be defined as a radial distance, in particular as the smallest possible radial distance, between a radially outer face of the axial wheel-hub sealing lip 62 and the radially outer end of the elastomeric wheel-hub sealing structure 60, which is arranged on a radially outer end of the radial wheel-hub sealing portion 56.

In preferred embodiments and as shown in FIG. 3, the axial inlet gap c may be smaller than or equal to the axial collecting gap e, which ensures that dirt, water and other particles are not directly let into the sealing labyrinth, i.e. into the region between the radial wheel-hub sealing portion 56 and the radial outer-ring sealing portion 74.

In other words, the elastomeric outer-ring sealing element 80, which is arranged on an axially outer end of the cylindrical outer-ring fastening portion 72 of the outer-ring sealing element 70, protrudes over the elastomeric wheel-hub sealing structure 60, which is arranged on a radially outer end of the radial wheel-hub sealing portion 56, which ensures that dirt, water and other particles are not directly let into the sealing labyrinth, i.e. into the region between the radial wheel-hub sealing portion 56 and the radial outer-ring sealing portion 74.

In other preferred embodiments and as shown in FIG. 3, the radial collecting height b may be greater than or equal to the axial collecting gap e, which ensures that dirt, water and other particles are not passively let into the sealing labyrinth, i.e. into the region between the radial wheel-hub sealing portion 56 and the radial outer-ring sealing portion 74, since the radial collecting height b together with the axial collecting gap e provides a buffering volume for any penetrating dirt, water or other particles.

In other words, the radial collecting height b may also be defined as a radial distance, in particular the smallest radial distance, along the elastomeric wheel-hub sealing structure 60, by way of example also along the radial wheel-hub sealing portion 56, between a radially outer face of the attachment of the axial wheel-hub sealing lip 62 on the elastomeric wheel-hub sealing structure 60 and the radially outer end of the slinger-ring element 51.

Furthermore, in FIG. 3, the sealing lips are provided with thickness references, and, in particular, the axial wheel-hub sealing lip 62 is provided with the thickness t₆₂₁, the axial outer-ring sealing lip 81 is provided with the thickness t₈₁, and the radial outer-ring sealing lip 82 is provided with the thickness t₈₂.

By means of the wheel-bearing device 10 or the sealing device 40, which is preferably configured to have a sealing labyrinth, as shown on the basis of FIGS. 2 and 3 by way of example, the number of sealing lips can be reduced, and in particular the number of dynamically contacting sealing lips, i.e. abrasive sealing lips such as the at least one axial outer-ring sealing lip 81 and the radial outer-ring sealing lip 82, can be reduced, which means that frictional losses or frictional torques during driving can be reduced by the wheel-bearing device 10 according to the invention.

Furthermore, by means of the wheel-bearing device 10 or the sealing device 40, which is preferably configured to have a sealing labyrinth, as shown on the basis of FIGS. 2 and 3 by way of example, the thicknesses of the sealing lips t₈₁, t₈₂ can be reduced, and in particular the thicknesses of the dynamically contacting sealing lips, i.e. abrasive sealing lips such as the at least one axial outer-ring sealing lip 81 and the radial outer-ring sealing lip 82, can be reduced, which means that the contact pressure of the sealing lips on the sealing surfaces or frictional surfaces can be reduced, and in turn frictional losses or frictional torques during driving can be reduced.

In preferred embodiments of the wheel-bearing device 10 or sealing device 40 for the wheel-bearing device 10, the thickness ratios of the thicknesses t₈₁, t₈₂ between the axial outer-ring sealing lip 81 and the radial outer-ring sealing lip 82 can be selected such that, on one hand, reliable sealing is provided by two dynamically contacting sealing lips 81, 82 and, on the other hand, only a small amount of material needs to be used to produce the axial and radial outer-ring sealing lip 81, 82. Furthermore, by providing a radial outer-ring sealing lip 82 which is configured to be dynamically contacting, the axial outer-ring sealing lip 81 can be configured to be thinner, according to preferred thickness ratios, which means that frictional losses of the wheel-bearing device 10 can be reduced.

Preferred ratios of the thickness t₈₁ of the axial outer-ring sealing lip 81 to the thickness t₈₂ of the radial outer-ring sealing lip 82 are in the range of from approximately 1.5 to approximately 4.0, preferably in the range of from approximately 1.7 to approximately 2.5, and particularly preferably in the range of from approximately 1.9 to approximately 2.1.

FIG. 4 is a sectional view of another exemplary embodiment of a wheel-bearing device 10 or sealing device 40 for a wheel-bearing device 10 in an axial direction a of the wheel-bearing device 10.

As shown in FIG. 4, the elastomeric wheel-hub sealing structure 60 may comprise a radial wheel-hub sealing lip 64 having a thickness t₆₄, with the radial wheel-hub sealing lip 64 contacting, in particular statically contacting, the wheel-hub element 20. By additionally arranging the radial wheel-hub sealing lip 64 in addition to the axial wheel-hub sealing lip 62, particularly reliable sealing against dirt, water and other particles getting into the axial gap between the axial wheel-hub end face 22 and the slinger-ring element 51 is provided, which prevents the slinger-ring element 51 from being pushed axially inwards or towards the center of the vehicle in the width direction of the vehicle over the service life of the wheel-bearing device 10. By preventing the slinger-ring element 51 from being pushed axially inwards over the service life of the wheel-bearing device 10, a sealing surface or frictional surface for the at least one axial outer-ring sealing lip 81 and optionally for the radial outer-ring sealing lip 82 can be kept constant over the service life of the wheel-bearing device 10, which means that the sealing function can advantageously be prevented from deteriorating and frictional losses can advantageously be prevented from increasing.

Furthermore, a radial wheel-hub sealing lip 64, which extends between the radial wheel-hub sealing portion 56 and the wheel-hub element 20 substantially in a radial direction and statically contacts the wheel-hub element 20, advantageously makes it possible for dirt, water or other particles that get into the axial gap between the slinger-ring element 51 and the wheel-hub element 30 or the axial wheel-hub end face 22 past the axial wheel-hub sealing lip 62 to still be reliably caught. Furthermore, dirt, water and other particles that have penetrated into the axial gap and have been caught by the radial wheel-hub sealing lip 64 can be thrown radially outwards by centrifugal action while the vehicle is being driven due to the rotation of the wheel-hub element 20 and the resulting rotation of the elastomeric wheel-hub sealing structure 60. Dirt, water and other particles that have penetrated into the axial gap past the axial wheel-hub sealing lip 62 can be expelled past the axial wheel-hub sealing lip 62. For example, the axial wheel-hub sealing lip 62 may be configured to elastically deform radially outwards or axially inwards when dirt, water and other particles that have got into the axial gap past the axial wheel-hub sealing lip 62 are expelled by centrifugal action on dirt, water and other particles that have penetrated. By the axial wheel-hub sealing lip 62 elastically deforming axially inwards or radially outwards, dirt, water and other particles that have penetrated can get out of the axial gap again, even after passing the axial wheel-hub sealing lip 62 into the axial gap. Therefore, a particularly preferred sealing device 40 that provides reliable sealing, and also a self-cleaning seal, can therefore be provided in an axial gap between the wheel-hub element 20 and the slinger-ring element 51.

The above-described effect, made possible by a preferred embodiment of the elastomeric wheel-hub sealing structure 60 comprising an axial wheel-hub sealing lip 62 and a radial wheel-hub sealing lip 64, can be further enhanced. To do this, in exemplary embodiments, the axial wheel-hub sealing lip 62 may be configured to taper towards the axial wheel-hub end face 22 in its axial extension in order to be slightly radially outwardly or axially inwardly elastically deformable in the region of the static contact of the axial wheel-hub sealing lip 62. Furthermore, the axial wheel-hub sealing lip 62 may for example be configured to extend substantially axially, with an increasing radius, towards the axial wheel-hub end face 22, as a result of which the axial wheel-hub sealing lip 62 has a radially outwardly directed curvature in its substantially axial extension in order to be slightly radially outwardly or axially inwardly elastically deformable. The above-mentioned exemplary configurations of the axial wheel-hub sealing lip 62 can be used both individually and together, and also so as to be over either the entire periphery or portions of the periphery.

Furthermore, the preferred embodiment of the elastomeric wheel-hub sealing structure 60 comprising an axial wheel-hub sealing lip 62 and a radial wheel-hub sealing lip 64 makes it possible, by arranging a radial wheel-hub sealing lip 64, for the axial wheel-hub sealing lip 62 having a thickness t₆₂₂ to be thinner than in an embodiment having a thickness t₆₂₁, the elastomeric wheel-hub sealing structure 60 not comprising a radial wheel-hub sealing lip 64. By means of a comparatively thinner configuration of the axial wheel-hub sealing lip 62 having a thickness t₆₂₂ (cf. FIG. 4), which is thinner than a thickness t₆₂₁ (cf. FIG. 3), any possible expulsion past the axial wheel-hub sealing lip 62 is made even easier and manufacturing costs are also reduced, while a sealing device 40 for a wheel-bearing device 10 which is particularly reliable and has a long service life is provided. In addition, a comparatively thinner axial wheel-hub sealing lip 62 having a thickness t₆₂₂ advantageously makes it possible for deformation of the wheel-hub flange or the inner axial wheel-hub end face 22 towards the slinger-ring element 51 to also be advantageously mitigated under load, i.e. during driving, which advantageously prevents the slinger-ring element 51 from being displaced towards the center of the vehicle over the service life of the wheel-bearing device 10. Therefore, the service life of the wheel-bearing device 10 is advantageously increased and the radial expulsion of dirt, water and other particles outwards past the axial wheel-hub sealing lip is simplified.

Furthermore, since a radial wheel-hub sealing lip 64 extends radially towards the wheel-hub element 20, it advantageously prevents thermally expanded air from escaping, i.e., in other words, it withstands an overpressure in the bearing 90 which develops due to heating during use, i.e. during driving.

In exemplary embodiments and as indicated by FIG. 5, the radial wheel-hub sealing lip 64 extends axially so as to be directed towards the center of the vehicle with an inclination, meaning that thermally expanded air can be particularly advantageously prevented from escaping by the radial wheel-hub sealing lip 64 being advantageously supported by the wheel-hub element 20 by means of an axially outwardly directed overpressure in the bearing 90 in the event of deformation. In other words, the radial wheel-hub sealing lip 64, which extends axially towards the center of the vehicle with an inclination, can particularly advantageously withstand an overpressure in the bearing 90. Preventing thermally expanded air from escaping from the bearing 90 therefore prevents a negative pressure from developing when the bearing 90 cools, i.e. after driving, meaning that dirt and water can be prevented from being drawn in after driving and a particularly reliable sealing function can be provided by the sealing device 40.

FIG. 5 is a sectional view of another exemplary embodiment of a wheel-bearing device 10 or sealing device 40 for a wheel-bearing device 10 in an axial direction a of the wheel-bearing device 10.

FIG. 5 in particular shows that a radial outer-ring sealing lip 82 can be configured to have a radial distance from the cylindrical wheel-hub fastening portion 54. In other words, the radial outer-ring sealing lip 82 can be configured not to touch or contact the cylindrical wheel-hub fastening portion 54. A radial outer-ring sealing lip 82 as shown in FIG. 5 makes it possible to advantageously reduce the frictional losses of the wheel-bearing device 10 during driving.

FIG. 6 is a sectional view of another exemplary embodiment of a wheel-bearing device 10 or sealing device 40 for a wheel-bearing device 10 in an axial direction a of the wheel-bearing device 10.

FIG. 6 in particular shows that an elastomeric outer-ring sealing structure 80 can comprise a first axial outer-ring sealing lip 81a and a second axial outer-ring sealing lip 81b in order to provide particularly reliable sealing against dirt, water and other particles getting in. In this case, the first axial outer-ring sealing lip 81a has a thickness t₈₁ₐ and the second axial outer-ring sealing lip 81b has a thickness t_{81b}. The thicknesses t₈₁ₐ and t_{81b} may be different from one another or may be the same. By means of the particularly reliable sealing, as provided by the first and the second axial outer-ring sealing lip 81a, 81b, the thicknesses t₈₁ₐ, t_{81b} of the first and the second outer-ring sealing lip 81a, 81b can be less than the thickness t₈₁ of a single outer-ring sealing lip.

While arranging a plurality of axial outer-ring sealing lips 81a, 81b in principle means that frictional losses of the wheel-bearing device 10 are increased, the improved sealing by the plurality of axial outer-ring sealing lips 81a, 81b makes it possible for the thicknesses t₈₁ₐ, t_{81b} of the plurality of axial outer-ring sealing lips 81a, 81b to be configured to be thinner, and therefore improved sealing is associated with only slightly higher frictional losses of the wheel-bearing device 10.

FIG. 7 is a sectional view of another exemplary embodiment of a wheel-bearing device 10 or sealing device 40 for a wheel-bearing device 10 in an axial direction a of the wheel-bearing device 10.

By way of example, FIG. 7 shows an embodiment in which two outer-ring sealing lips 81a, 81b are provided by the elastomeric outer-ring sealing structure 80, and furthermore a radial outer-ring sealing lip 82 is arranged on the elastomeric outer-ring sealing structure 80 which contacts the cylindrical wheel-hub fastening portion 54, which therefore provides a wheel-bearing device 10 comprising a sealing device 40 that provides particularly reliable sealing.

FIG. 8 shows an exemplary embodiment similar to FIG. 7, in which the slinger-ring element 51 does not comprise a wheel-hub labyrinth portion, which therefore provides a wheel-bearing device 10 comprising a sealing device 40 that provides reliable sealing while the production of a slinger-ring element 51 is simplified.

### LIST OF REFERENCE CHARACTERS

10 wheel-bearing device
20 wheel-hub element
22 axial wheel-hub end face
24 cylindrical wheel-hub portion
28 wheel fastening portion
30 outer-ring element
32 radial outer-ring inner face
34 axially outer end (of the outer-ring element)
36 radial outer-ring outer face
38 outer-ring fastening portion
40 sealing device
50 wheel-hub sealing element
51 (metal) slinger-ring element
54 cylindrical wheel-hub fastening portion
56 radial wheel-hub sealing portion
57 inclined inner wheel-hub sealing transition portion
58 wheel-hub labyrinth portion
60 elastomeric wheel-hub sealing structure
62 axial wheel-hub sealing lip
64 radial wheel-hub sealing lip
70 outer-ring sealing element
71 (metal) insertion element
72 cylindrical outer-ring fastening portion
74 radial outer-ring sealing portion
76 first radial outer-ring sealing segment
77 outer-ring sealing transition portion
78 second radial outer-ring sealing segment
80 elastomeric outer-ring sealing structure
81 axial outer-ring sealing lip
81a first axial outer-ring sealing lip
81b second axial outer-ring sealing lip
82 radial outer-ring sealing lip
84 collecting-lip structure
86 collecting lip
88 blocking lip
90 rolling bearing
a axial direction or axis of the wheel-bearing device
a_{outwards} axial direction outwards or direction axially outwards
a_{inwards} axial direction inwards or direction axially inwards
r radial direction
b radial collecting height
c axial inlet gap
d axial outlet gap
d axial collecting gap
t thickness of the relevant element
V magnification region

1. Wheel-bearing device (10), comprising:
an outer-ring element (30) for connection to a vehicle body,
a wheel-hub element (20) for connection to a wheel, and
a sealing device (40), which seals a gap between the outer-ring element (30) and the wheel-hub element (20), wherein
the wheel-hub element (20) comprises an inner axial wheel-hub end face (22), which faces the outer-ring element (30), and a cylindrical wheel-hub portion (24), which is arranged in the radial interior of the outer-ring element (30) at least in part,
the outer-ring element (30) comprises a radial outer-ring inner face (32), which faces the cylindrical wheel-hub portion (24),
the sealing device (40) comprises a wheel-hub sealing element (50), which is mounted on the wheel-hub element (20), and an outer-ring sealing element (70), which is mounted on the outer-ring element (30),
the wheel-hub sealing element (50) comprises a substantially rigid slinger-ring element (51) and an elastomeric wheel-hub sealing structure (60) arranged thereon,
the outer-ring sealing element (70) comprises a substantially rigid insertion element (71) and an elastomeric outer-ring sealing structure (80) arranged thereon,
the slinger-ring element (51) comprises a cylindrical wheel-hub fastening portion (54), which is connected to the cylindrical wheel-hub portion (24), and a radial wheel-hub sealing portion (56), which extends outwards from the wheel-hub element (20) substantially in a radial plane,
the insertion element (71) comprises a cylindrical outer-ring fastening portion (72), which is connected to the radial outer-ring inner face (32), and a radial outer-ring sealing portion (74), which extends inwards from the outer-ring element (30) substantially in a radial plane,
the elastomeric outer-ring sealing structure (80) comprises an axial outer-ring sealing lip (81), which extends between the radial outer-ring sealing portion (74) and the radial wheel-hub sealing portion (56) substantially in an axial direction and contacts the radial wheel-hub sealing portion (56),
the radial wheel-hub sealing portion (56) is arranged so as to be axially spaced from the inner axial wheel-hub end face (22), and
the elastomeric wheel-hub sealing structure (60) comprises an axial wheel-hub sealing lip (62), which extends between the radial wheel-hub sealing portion (56) and the inner axial wheel-hub end face (22) substantially in an axial direction and contacts the inner axial wheel-hub end face (22).

2. Wheel-bearing device (10) according to claim 1, wherein
the elastomeric wheel-hub sealing structure (60) comprises a radial wheel-hub sealing lip (64), which extends between the radial wheel-hub sealing portion (56) and the wheel-hub element (20) substantially in a radial direction and contacts the wheel-hub element (20).

3. Wheel-bearing device (10) according to claim 2, wherein the elastomeric wheel-hub sealing structure (60) only comprises the axial wheel-hub sealing lip (62) and the radial wheel-hub sealing lip (64) for contacting the wheel-hub element (20).

4. Wheel-bearing device (10) according to either of claims 2 or 3, wherein a thickness ratio of the axial wheel-hub sealing lip (62) to the radial wheel-hub sealing lip (64) is in the range of from approximately 1.5 to approximately 4.0;
preferably in the range of from approximately 1.7 to approximately 2.5; and
particularly preferably in the range of from approximately 1.9 to approximately 2.1.

5. Wheel-bearing device (10) according to any of claims 1 to 4, wherein
the elastomeric outer-ring sealing structure (80) comprises a radial outer-ring sealing lip (82), which extends between the radial outer-ring sealing portion (74) and the cylindrical wheel-hub fastening portion (54) substantially in a radial direction and in particular contacts the cylindrical wheel-hub fastening portion (54).

6. Wheel-bearing device (10) according to claim 5, wherein the elastomeric outer-ring sealing structure (80) only comprises the axial outer-ring sealing lip (81) and the radial outer-ring sealing lip (82) for contacting the slinger-ring element (51).

7. Wheel-bearing device (10) according to either of claims 5 or 6, wherein a thickness ratio of the axial outer-ring sealing lip (81) to the radial outer-ring sealing lip (82) is in the range of from approximately 1.5 to approximately 4.0;
preferably in the range of from approximately 1.7 to approximately 2.5; and
particularly preferably in the range of from approximately 1.9 to approximately 2.1.

8. Wheel-bearing device (10) according to any of claims 1 to 7, wherein the outer-ring sealing element (70) comprises a collecting-lip structure (84), which extends between an axially outer end of the outer-ring element (30) and the wheel-hub end face (22), on the axially outer end of the outer-ring element (30),
wherein a collecting lip (86), which extends so as to be inclined radially outwards, is arranged on the collecting-lip structure (84),
wherein an axial outlet gap (d) is configured between the collecting lip (86) and the wheel-hub end face (22).

9. Wheel-bearing device (10) according to claim 8, wherein the collecting-lip structure (84) comprises a substantially radially outwardly extending blocking lip (88), which extends radially beyond a radial outer-ring outer face (36).

10. Wheel-bearing device (10) according to any of claims 1 to 9, wherein the slinger-ring element (51) comprises a wheel-hub labyrinth portion (58), which is arranged radially outside the cylindrical wheel-hub fastening portion (54) and extends from the radial wheel-hub sealing portion (56) substantially axially towards the radial outer-ring sealing portion (74).

11. Wheel-bearing device (10) according to claim 10, wherein
the radial outer-ring sealing portion (74) is configured in portions, wherein a first radial outer-ring sealing segment (76) extends axially further inwards than a second radial outer-ring sealing segment (78),
the first radial outer-ring sealing segment (76) is arranged radially outside the second radial outer-ring sealing segment (78),
the first radial outer-ring sealing segment (76) is connected to the second radial outer-ring sealing segment (78) by a transition portion (77), such that the outer-ring element (30) comprises an axially inwardly recessed peripheral cavity, and
the wheel-hub labyrinth portion (58) extends towards the cavity and preferably extends into the cavity.

12. Wheel-bearing device (10) according to any of claims 1 to 11, comprising:
an axial inlet gap (c), which is defined as an axial distance between the wheel-hub end face (22) and the outer-ring sealing element (70);
an axial collecting gap (e), which is defined as an axial distance between the wheel-hub end face (22) and a radially outer end of the elastomeric wheel-hub sealing structure (60);
a radial collecting height (b), which is defined as a radial distance between a radially outer face of the axial wheel-hub sealing lip (62) and the radially outer end of the elastomeric wheel-hub sealing structure (60); wherein
the radial collecting height (b) is greater than the axial collecting gap (e); and/or
the axial inlet gap (c) is smaller than or equal to the axial collecting gap (e).
